(19) United States
(12) Patent Application Publication
(10) Pub. No.: US 2008/0265539 A1
(43) Pub. Date: Oct. 30, 2008

(54) Truck assembly without wheels for illuminating a sport board, such as a skateboard

(76) Inventor: Dennis P. Gregorio, Bethany Beach, DE (US)

Correspondence Address: DINESH AGARWAL, P.C., 5350 SHAWNEE ROAD, SUITE 330, ALEXANDRIA, VA, 22312, US

(21) Appl. No.: 11/790,929

(22) Filed: Apr. 30, 2007

(51) Int. Cl. B60Q 1/26; B60Q 1/00; B62M 1/00

(52) U.S. Cl. 280/87.041; 362/459

(57) ABSTRACT

A truck assembly without wheels for illuminating a sport board, such as a skateboard, includes a support base, a truck axle connected to the support base, a light-emitting member connected to the truck axle, and an electrical member for supplying power to the light-emitting member.

### FIELD AND BACKGROUND OF THE INVENTION

The present invention is generally directed to sports accessories, and more particularly to a truck assembly without wheels for illuminating a sport board, such as a skateboard.

Various outdoor sports have experienced tremendous growth in popularity in the last decade. Although sports, such as roller skating, skiing, surfing, and the like, can be called as traditional sports, which have been around for many decades, the skateboarding, snowboarding, rollerblading, etc., are more of recent phenomena. The skill, maneuverability, action, and sportsmanship displayed by many enthusiasts, amateur or professional, are not only amazing, but also aggressive. It is not, therefore, surprising that both the snowboarding and skateboarding, for example, are now part of the Olympics. The pride of having won a medal at the Olympics, or at a local, state, or national competition/championship, can be easily understood. Even more understandable is the desire on the part of an athlete or sports enthusiast to display his/her favorite or special sport board, and particularly any art work or design thereon, as explained below.

When simply riding a board, or during a maneuver, the top and undersides, and particularly the underside, often comes in full view of the spectators. Therefore, it is not uncommon for the riders to decorate, particularly the underside of their boards, with artwork, design, or other information.

In addition, It is often desirable to decorate, particularly the underside of a board, with a design or other information for personal or commercial reasons. For instance, various manufacturers decorate the underside of their boards with their proprietary logo or other design to distinguish their product line from their competition. Likewise, a skateboarder may wish to decorate the underside of a skateboard with his/her favorite design, art work, or other information.

The desire or need to display the design, art work, or other information, on a skateboard, for example, is not merely limited to during its use. A medal or prize winner may wish to display the board on a wall, in much the same manner as, for example, a sport fisherman who displays his/her big catch. Likewise, a retail establishment may hang or suspend various lines of skateboards, snowboards, skis, etc., on a wall for point-of-sale display purposes. However, it is often difficult to fully see, and thus, appreciate the artwork or other design on a sport board due to insufficient or poor lighting conditions. It would, therefore, be desirable to have a dedicated lighting for the sport board for its full illumination.

The term “truck”, when used in conjunction with a skateboard, refers to a wheeled steering mechanism that typically includes an axle with two wheels, pivotally mounted to a base attachable to the underside of a skateboard. The base typically includes four holes in alignment with four holes on the skateboard for inserting screws therethrough to mount the truck to the underside of the skateboard.

Various lighting devices are disclosed in U.S. Pat. Nos. 3,789,208; 4,363,502; 5,278,733; 5,683,164; 6,828,916; 2005/0030746; and Des. 268,195. None of the conventional devices, however, appear to be directed to a truck assembly without wheels for illuminating a sport board, such as a skateboard.

Therefore, there is a need in the industry for a truck assembly without wheels which can be used to illuminate a sport board, such as a skateboard.

### OBJECTS AND SUMMARY OF THE INVENTION

The principal object of the present invention is to provide a truck assembly without wheels for illuminating a sport board, such as a skateboard, and particularly the underside thereof.

Another object of the present invention is to provide a truck assembly without wheels for illuminating a sport board, such as skateboard, which can be easily retrofitted by first removing the existing truck assembly with the wheels and mounting the truck assembly of the present invention in place thereof.

Another object of the present invention is to provide a truck assembly without wheels for illuminating a sport board, such as skateboard, which allows a sport enthusiast to proudly display any artwork, design or other information on the skateboard.

Another object of the present invention is to provide a truck assembly without wheels for illuminating a sport board, such as skateboard, which allows a manufacturer, dealer or retailer to distinguish different sport boards easily and prominently.

Another object of the present invention is to provide a truck assembly without wheels for illuminating a sport board, such as skateboard, which allows a manufacturer, dealer or retailer to proudly display their trademark, logo, or other selected design on their product line.

In summary, the main object of the present invention is to provide a truck assembly without wheels which can be used to illuminate a sport board, such as a skateboard, and particularly the underside thereof to improve the visibility of or to enhance the design, artwork or other information thereon.

One of the above objects is met, in part, by the present invention, which in one aspect includes a truck assembly without wheels for illuminating a sport board, such as a skateboard, including a support base, a truck axle connected to the support base, a light-emitting member connected to the truck axle, and an electrical member for supplying power to the light-emitting member.

Another aspect of the present invention includes a truck assembly without wheels for illuminating a sport board, which includes a support base for mounting to a sport board, a truck axle operably connected to the support base and including first and second ends, a light-emitting member operably connected to one of the first and second ends of the truck axle, and an electrical member for supplying power to the light emitting member. The electrical member extends through the truck axle and the support base.

Another aspect of the present invention includes a sport board, which includes a deck including top and undersides, a truck assembly without wheels mounted to the underside of the deck. The truck assembly includes a support base, a truck axle operably connected to the support base, at least one light-emitting member operably connected to the truck axle, and an electrical member for supplying power to the light-emitting member.

### BRIEF DESCRIPTION OF THE DRAWINGS

One of the above objects, novel features and advantages of the present invention will become apparent from the following detailed description of the preferred embodiment(s) of the invention, as illustrated in the drawings, in which:

FIG. 1 is a perspective underside view of a skateboard with two conventional truck assemblies with wheels;

FIG. 2 is a perspective underside view of the skateboard of FIG. 1, shown retrofitted with two truck assemblies without wheels of the present invention;

FIG. 3 is a partial, enlarged view of the skateboard of FIG. 1, showing removal of the conventional truck assembly with wheels;

FIG. 4 is a view similar to FIG. 3, showing installation of the truck assembly without wheels of the present invention;

FIG. 5 is an elevational view of the skateboard of FIG. 2, showing the underside thereof being illuminated by the truck assemblies of the present invention;

FIG. 6 is a perspective top side view of the skateboard of FIG. 5, showing electrical connection details;

FIG. 7 is a partial enlarged view of the skateboard of FIG. 4, partially in cross-section to show electrical connections; and

FIG. 8 is a side elevational view of the skateboard of FIG. 7, partially in cross-section to show the mounting/electrical details.

### DETAILED DESCRIPTION OF THE PREFERRED EMBODIMENT(S) OF THE INVENTION

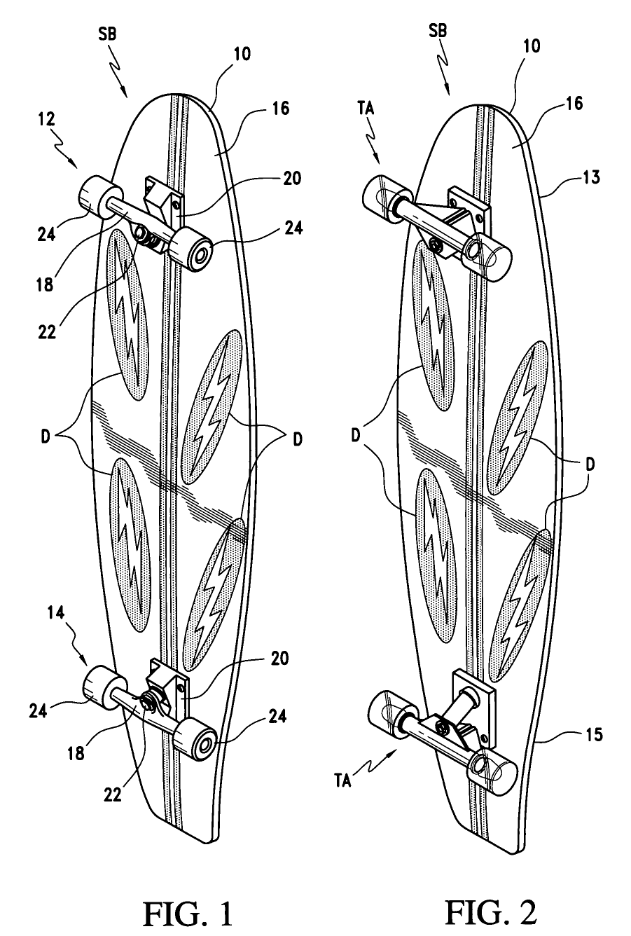

Referring to FIG. 1, a skateboard SB includes a deck 10 and conventional nose and tail truck assemblies 12 and 14, respectively, mounted on the underside 16 thereof. Each truck assembly 12 and 14, includes an axle 18 pivotally mounted to a base block 20 at location 22. Wheels 24 are provided on the ends of the axle 18.

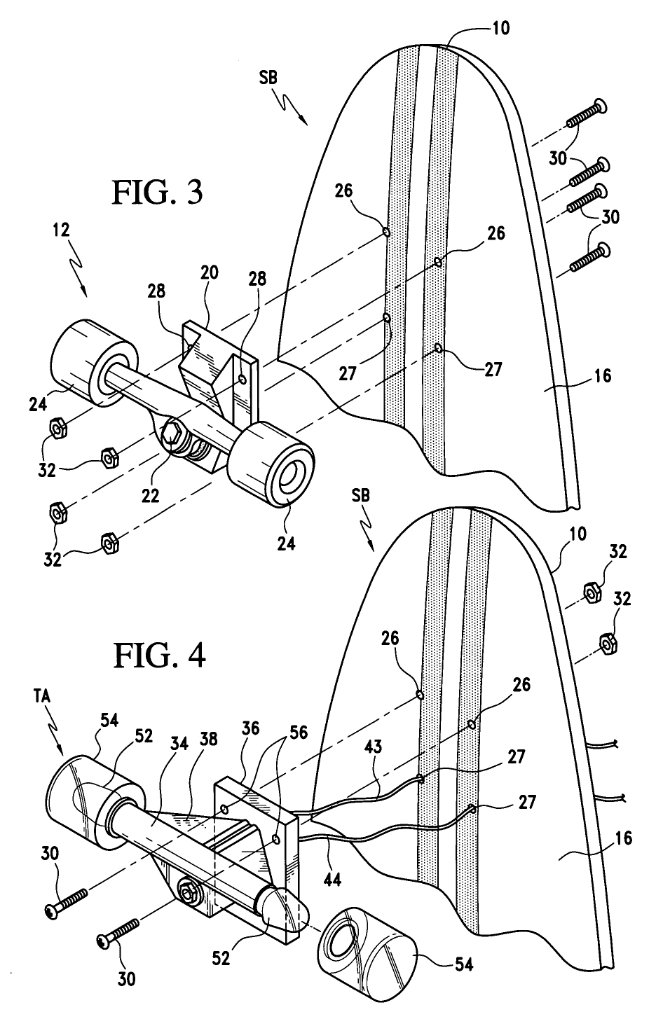

As best shown in FIG. 3, the deck 10 includes two upper holes 26 and two lower holes 27 that are in alignment with the corresponding holes 28 in the base block 20. (It is noted herewith that the nose and tail truck assemblies 12 and 14 are identical in configuration and are mounted on the deck 10 in the same manner.) The truck assemblies 12 and 14 are mounted to the deck 10 by using conventional screws 30 and nuts 32, in a known manner.

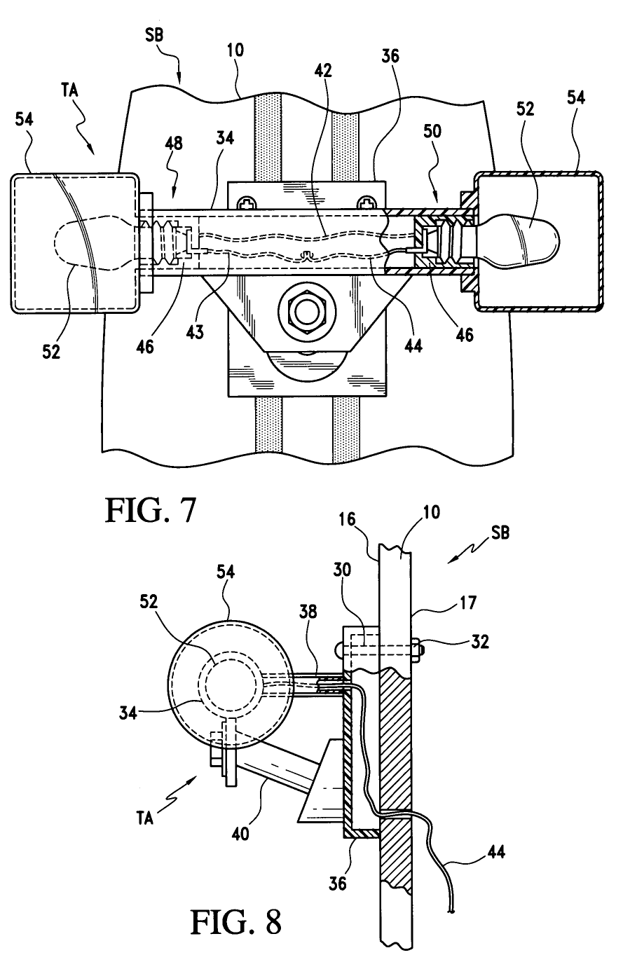

FIGS. 2-8 depict the truck assembly TA of the present invention. As best shown in FIGS. 4, 7 and 8, the truck assembly TA of the present invention includes an axle 34, preferably rigidly mounted to a support base 36 by using upper and lower brackets 38 and 40, respectively. The axle 34, the bracket 38, and the support base 36, are preferably hollow for extending the wiring 42, 43 and 44 therethrough, and through the holes 26, towards the top side 17 of the skateboard SB (FIGS. 6 and 8). (It is noted herewith that the axle 34, support base 36, and the brackets 38 and 40, may be molded or made as one integral/monolithic piece with appropriate passageways for the wiring, if desired.) A socket 46 is provided at both ends 48 and 50 of the axle 34. The sockets 46 are adapted to receive a incandescent bulb 52, or any other conventional light-emitting members, such as a diode, fluorescent bulb, etc. A generally clear or translucent cover 54 is mounted over each bulb 52 to protect from accidental damage. The cover 54 may be colored to provide a desired effect. As best shown in FIG. 4, the support base 36 includes two holes 56 that are in alignment with the two upper holes 26 in the deck 10.

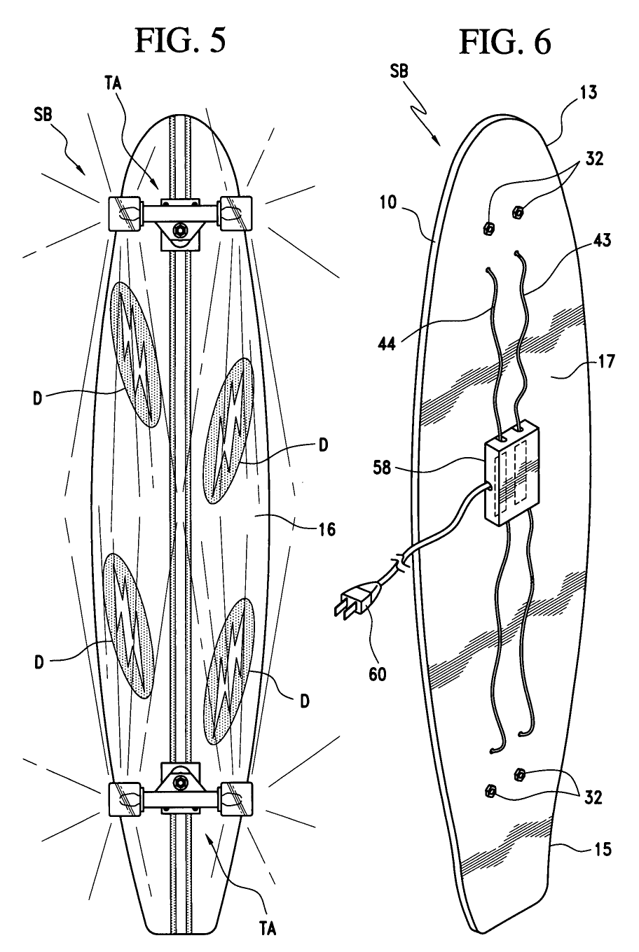

In order to mount or retrofit the truck assembly TA of the present invention onto the skateboard SB, the conventional truck assemblies 12 and 14 with the wheels are first removed (FIG. 3—only the nose assembly 12 is shown). The truck assembly TA of the present invention is then mounted by using, preferably two screws 30 and the corresponding nuts 32, through the holes 56 in the support base 36 and through the two upper holes 26 in the deck 10 (FIG. 4). The wiring 43 and 44 are threaded through the bottom two holes 27 in the deck 10 to be connected to a junction box 58 on the top side 17 (FIG. 6). Once both the truck assemblies TA are mounted adjacent nose and tail ends 13 and 15, respectively, of the skateboard SB, the plug 60 may be connected to a power source, such as a wall receptacle or the like (not shown), to illuminate the design D on the underside 16 of the skateboard SB (FIG. 5). It is noted herewith that although it is preferred that both the truck assemblies 12 and 14, be substituted by the truck assemblies TA of the present invention, for symmetry and proper illumination, it is not necessary to do so. In other words, only one of the truck assemblies 12 and 14 may be substituted by the truck assembly TA of the invention, as desired.

Although the truck assembly TA has been illustrated/shown to be configured for electrical power, it is within the scope of this invention to use battery power in place thereof or in conjunction therewith.

From the above, it can be readily observed that the truck assembly TA of the present invention can be used as a dedicated light assembly for illuminating the underside of a skateboard. A skateboard illuminated in this manner, would have a significantly better or enhanced visibility of any artwork, design, or other information provided on the underside thereof.

It is noted herewith that although the instant application describes the use of the truck assembly TA of the present invention in conjunction with a skateboard, it will be understood that it could also be used in connection with other sport boards, such as, for example, snowboards, surfboards, boogie boards, etc., or skis.

While this invention has been described as having preferred sequences, ranges, steps, materials, structures, features, and/or designs, it is understood that it is capable of further modifications, uses and/or adaptations of the invention following in general the principle of the invention, and including such departures from the present disclosure as those come within the known or customary practice in the art to which the invention pertains, and as may be applied to the central features hereinbefore set forth, and fall within the scope of the invention and of the limits of the appended claims.

What is claimed is:

1. A truck assembly without wheels for illuminating a sport board, comprising:
a) a support base;
b) a truck axle operably connected to said support base;
a) at least one light-emitting member operably connected to said truck axle; and
b) an electrical member for supplying power to said light-emitting member.

2. The truck assembly of claim 1, wherein:
a) said support base includes at least one hole for mounting the truck assembly to a sport board.

3. The truck assembly of claim 2, wherein:
a) said electrical member extends through said truck axle.

4. The truck assembly of claim 3, wherein:
a) said electrical member extends through said support base.

5. The truck assembly of claim 1, wherein:
a) said truck axle includes first and second ends; and
b) each of said first and second ends includes one said light-emitting member operably connected thereto.

6. The truck assembly of claim 5, wherein:
a) said light-emitting member is selected from the group consisting of a diode, an incandescent bulb, and a fluorescent bulb.

7. The truck assembly of claim 5, further comprising:
a) a generally transparent or translucent cover for each said light-emitting member.

8. The truck assembly of claim 1, wherein the sport board comprises a skateboard.

9. The truck assembly of claim 1, in combination with a skateboard.

10. A truck assembly without wheels for illuminating a sport board, comprising:
a) a support base for mounting to a sport board;
b) a truck axle operably connected to said support base and including first and second ends;
c) a light-emitting member operably connected to one of said first and second ends of said truck axle;
d) an electrical member for supplying power to said light emitting member; and
e) said electrical member extending through said truck axle and said support base.

11. The truck assembly of claim 10, wherein:
a) another light-emitting member is operably connected to the other of said first and second ends of said truck axle.

12. The truck assembly of claim 11, further comprising:
a) a generally transparent or translucent cover for each of said light-emitting members.

13. The truck assembly of claim 10, wherein the sport board comprises a skateboard.

14. The truck assembly of claim 10, in combination with a skateboard.

15. A sport board, comprising:
a) a deck including top and undersides;
b) a truck assembly without wheels mounted to the underside of said deck; and
c) said truck assembly including:
i) a support base;
ii) a truck axle operably connected to said support base;
iii) at least one light-emitting member operably connected to said truck axle; and
iv) an electrical member for supplying power to said light-emitting member.

16. The sport board of claim 15, wherein:
a) said electrical member extends through said truck axle and said support base.

17. The sport board of claim 16, wherein:
a) said deck includes a hole; and
b) said electrical member extends through the hole in said deck.

18. The sport board of claim 15, further comprising:
a) a generally transparent or translucent cover for said light-emitting member.

19. The sport board of claim 15, comprising:
a) a plurality of said truck assemblies.

20. The sport board of claim 15, wherein:
a) the sport board comprises a skateboard.
